(19) United States
(12) Patent Application Publication
(10) Pub. No.: US 2021/0033120 A1
(43) Pub. Date: Feb. 4, 2021

(54) THROTTLE VALVE FOR A PNEUMATIC TOOL

(71) Applicant: BASSO INDUSTRY CORP., Taichung (TW)

(72) Inventor: Chun-Chi LAI, Taichung (TW)

(73) Assignee: BASSO INDUSTRY CORP., Taichung (TW)

(21) Appl. No.: 16/940,883

(22) Filed: Jul. 28, 2020

(30) Foreign Application Priority Data
Jul. 30, 2019 (TW) 108127048

(51) Int. Cl. F15D 1/02; B25F 5/02

(52) U.S. Cl. CPC F15D 1/025; B25C 1/047; B25F 5/02

(57) ABSTRACT

A throttle valve is adapted for use in a pneumatic tool. The throttle valve includes a valve body and a filling unit. The valve body has a passage having an entrance section that is formed in one end surface of the valve body, and an exit section that is formed in another end surface of the valve body and that is adapted to be connected directly to a flow path unit of the pneumatic tool. The filling unit is disposed in the passage and cooperatively defines with the valve body a gap, such that the gas flows into the gap via the entrance section of the passage, and flows out of the gap via the exit section of the passage.

### CROSS-REFERENCE TO RELATED APPLICATION

This application claims priority of Taiwanese Invention Patent Application No. 108127048, filed on July. 30, 2019.

### FIELD

The disclosure relates to a throttle valve, more particularly to a throttle valve for a pneumatic tool.

### BACKGROUND

A type of pneumatic tool, such as a nail gun, that can be switched between single-shot and continuous modes is disclosed in U.S. Pat. No. 10335936 or U.S. Patent Publication No. 20140231485. In the continuous mode, a trigger of the pneumatic tool may be continuously depressed and a safety member (or force transmission element) subsequently depressed to enable continuous firing of the pneumatic tool. By virtue of a conventional throttle valve installed in the pneumatic tool, gas flow is controlled so as to enable firing of the pneumatic tool within a predetermined delay time, or to prevent firing of the pneumatic tool when the predetermined delay time has been exceeded.

The throttle valve must only let minute amounts of gas flow therethrough, and is formed with a very small through hole with a diameter of around 0.2 mm which requires high precision processing. Forming such a hole is very complicated and results in a relatively high manufacturing cost of the throttle valve.

### SUMMARY

Therefore, the object of the disclosure is to provide a throttle valve that can alleviate the drawback of the prior art.

According to the disclosure, a throttle valve is adapted for use in a pneumatic tool. The pneumatic tool includes a tool body, a flow path unit disposed in the tool body, and a valve assembly disposed inside the flow path unit and movable by pressure that is generated from gas which flows through the flow path unit . The throttle valve includes a valve body and a filling unit.

The valve body has a passage having an entrance section that is formed in one end surface of the valve body, and an exit section that is formed in another end surface of the valve body and that is adapted to be connected directly to the flow path unit.

The filling unit is disposed in the passage and cooperatively defines with the valve body a gap, such that the gas flows into the gap via the entrance section of the passage, and flows out of the gap via the exit section of the passage.

### BRIEF DESCRIPTION OF THE DRAWINGS

Other features and advantages of the disclosure will become apparent in the following detailed description of the embodiment with reference to the accompanying drawings, of which:

FIG. 1 is a sectional view of a pneumatic tool mounted with an embodiment of a throttle valve according to the disclosure;

FIG. 2 is a cutaway view illustrating a flow path unit, a conditioning valve assembly and a switch valve assembly of the pneumatic tool;

FIG. 3 is a partly exploded sectional view of the embodiment;

FIG. 4 is a sectional view of the embodiment installed in the pneumatic tool;

FIG. 5 is a sectional view taken along line V-V in FIG. 4;

FIG. 6 is a view similar to FIG. 5 but illustrating a transverse section of a filling member of the embodiment having a square shape;

FIG. 7 is a view similar to FIG. 5 but illustrating the transverse section of the filling member having a truncated circle shape;

FIG. 8 is a view similar to FIG. 4 but illustrating a passage of the embodiment having two passage portions;

FIG. 9 is a view similar to FIG. 8 but illustrating two filling members respectively disposed inside the passage portions;

FIG. 10 is a view similar to FIG. 1 but illustrating the passage of the embodiment being directly communicated with a main chamber of the pneumatic tools;

FIG. 11 is a view similar to FIG. 8 but illustrating the filling member mounted to a tool body of the pneumatic tool; and

FIG. 12 is a view similar to FIG. 9 but illustrating one of the filling members mounted to a valve body of the embodiment.

### DETAILED DESCRIPTION

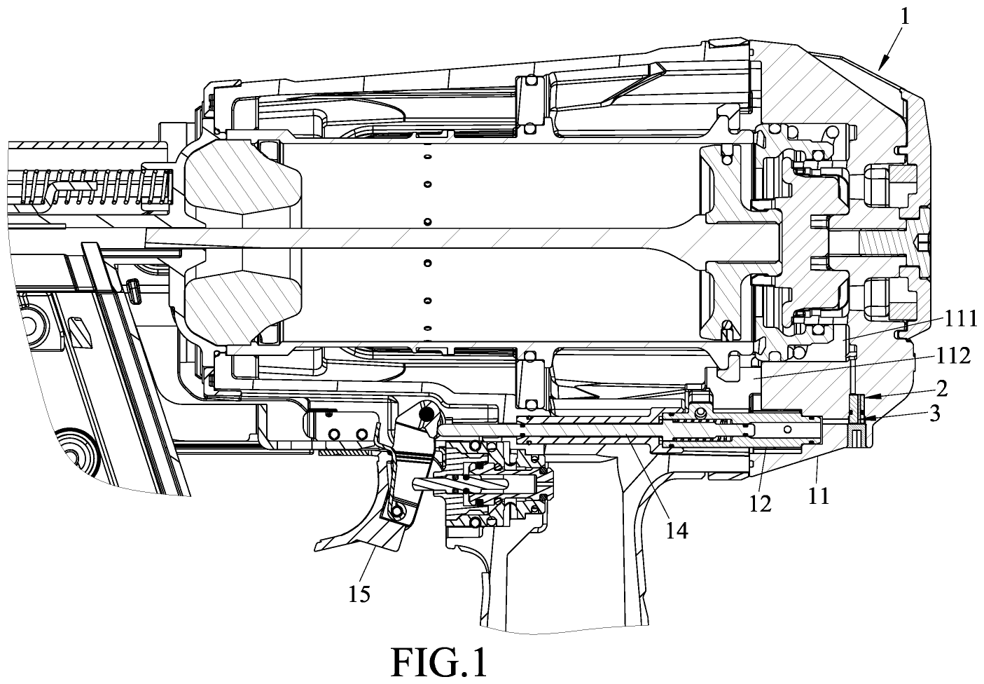

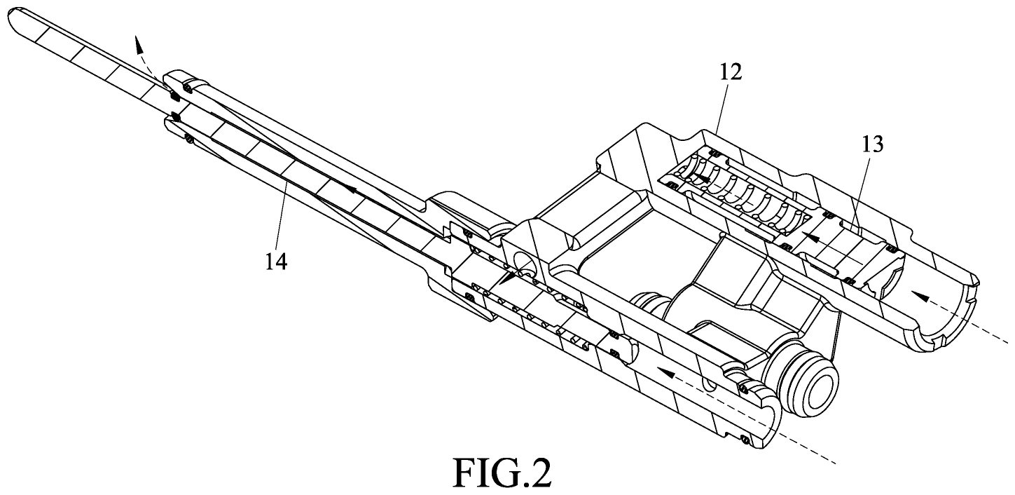

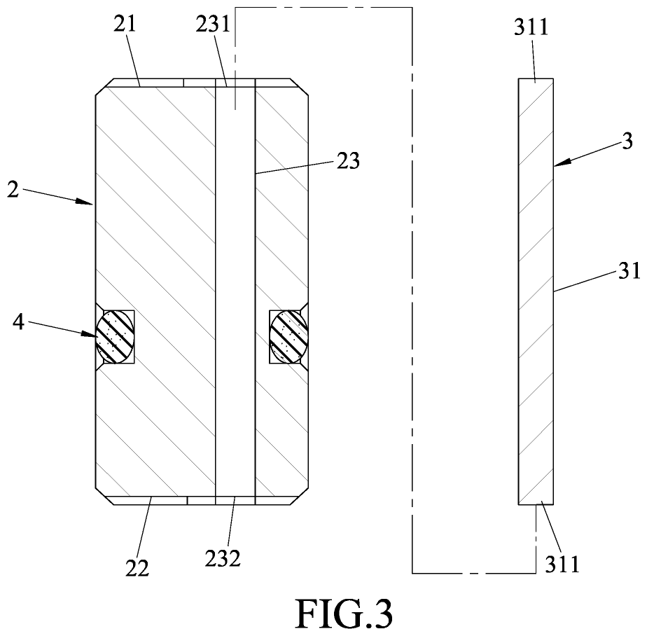

Referring to FIGS. 1, 2 and 3, an embodiment of a throttle valve is adapted for use in a pneumatic tool 1. In this embodiment, the pneumatic tool 1 is a pneumatic nail gun.

The pneumatic tool 1 includes a tool body 11, a flow path unit 12 disposed in the tool body 11 and directly communicated with the external environment, and conditioning and switch valve assemblies 13, 14 disposed movably in the flow path unit 12. The tool body 11 defines an operating chamber 111 and a main chamber 112 that are communicable via the flow path unit 12.

The conditioning valve assembly 13 is movable by pressure generated from gas which flows through the flow path unit 12 to stop the main chamber 112 from communicating with the external environment and the operating chamber 111 through the flow path unit 12. The switch valve assembly 14 is driven by a trigger 15 to move to block direct communication between the flow path unit 12 and the external environment. When direct communication between the flow path unit 12 and the external environment is blocked, the conditioning valve assembly 13 is moved to a position where communication between the operating chamber 111 and the main chamber 112 is allowed, which equalizes the gas pressure between the operating chamber 111 and the main chamber 112, preventing the gas pressure in the main chamber 112 from being used to performing pneumatic action.

Referring to FIGS. 1, 3, 4, and 5, the throttle valve includes a valve body 2, a filling unit 3, and a sealing ring 4.

In this embodiment, the valve body 2 has a passage 23 having an entrance section 231 that is formed in one end surface 21 of the valve body 2, and an exit section 232 that is formed in another end surface 22 of the valve body 2 and that is adapted to be connected directly to the flow path unit 12. The passage 23 has a transverse section being circular.

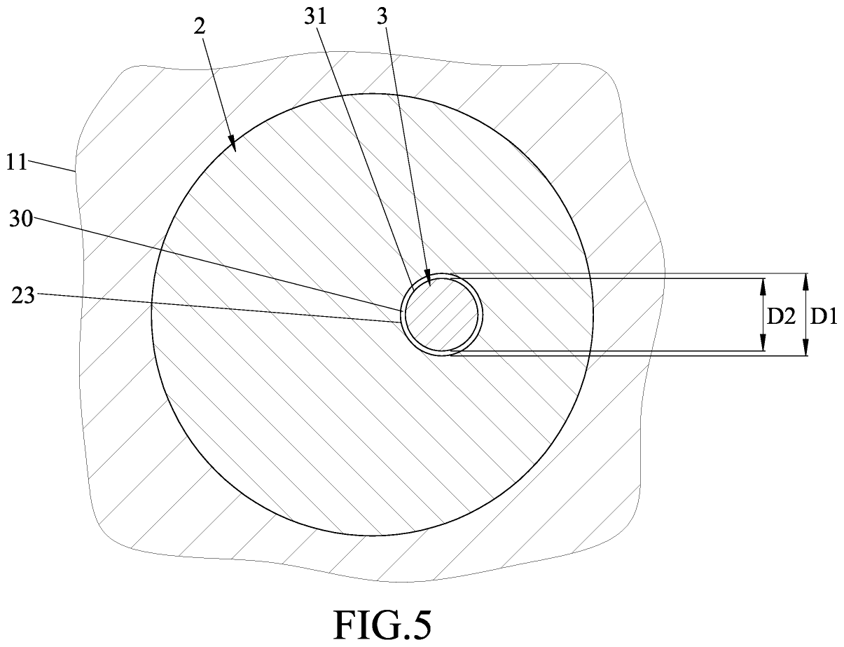

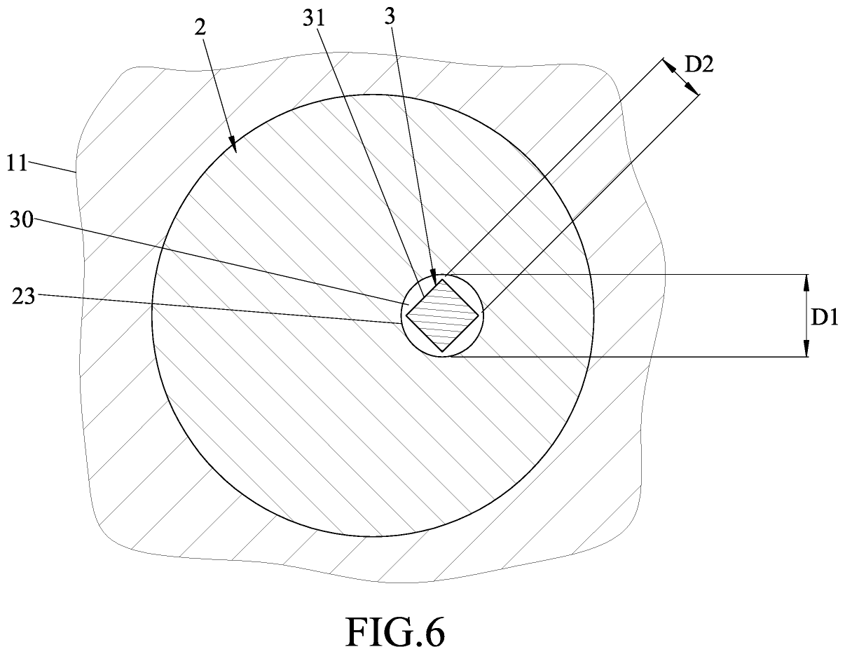

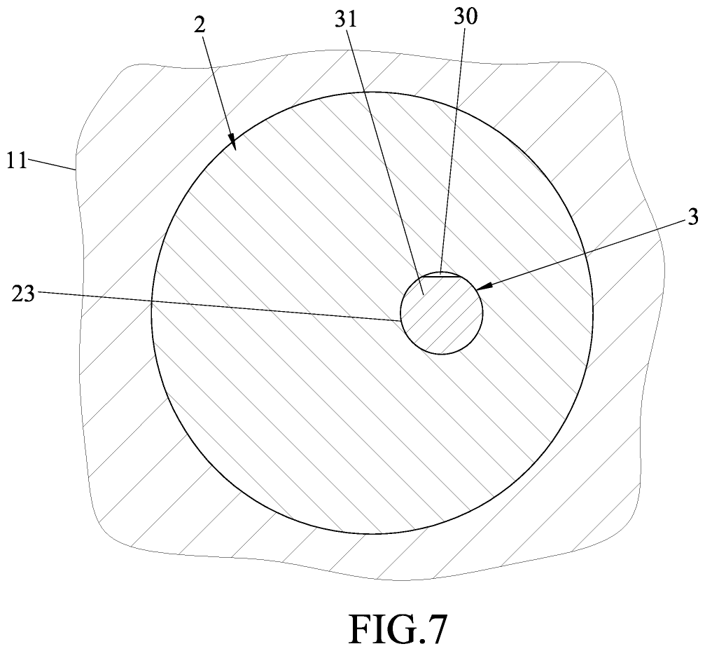

In this embodiment, the filling unit 3 includes a filling member 31 extending through the passage 23. The filling member 31 cooperatively defines with the valve body 2 a gap 30 such that the gas flows into the gap 30 via the entrance section 231 of the passage 23, and flows out of the gap 30 via the exit section 232 of the passage 23. In this embodiment, the filling member has two mounted ends 311 adapted to be mounted to the tool body 11. The filling member 31 has a transverse section having a shape of one of a circle (FIG. 5), a polygon (FIG. 6) , and a truncated circle (FIG. 7) such that the gap 30 has an equivalent diameter(d).

The sealing ring 4 is sleeved on the valve body 2 and is adapted to be disposed between an outer surface of the valve body 2 and the tool body 11 to stop passage of gas therebetween.

In this embodiment, the transverse section of the filling member 31 is a circle having a diameter (D2) smaller than a diameter (D1) of the transverse section of the passage 23. Specifically, by forming the passage 23 having the diameter (D1) as listed in Table 1 and the filling member 31 having the corresponding diameter (D2) in Table 1, the gap 30 may have the equivalent diameter (d) which ranges from 0.11 mm to 0.49 mm.

TABLE 1

| Diameter (D1) | Diameter (D2) | Equivalent Diameter (d) |
|---|---|---|
| 0.32 mm | 0.30 mm | 0.11 mm |
| 0.52 mm | 0.50 mm | 0.14 mm |
| 1.02 mm | 1.00 mm | 0.20 mm |
| 1.52 mm | 1.50 mm | 0.25 mm |
| 2.02 mm | 2.00 mm | 0.28 mm |
| 6.02 mm | 6.00 mm | 0.49 mm |

In the following description, the calculation for obtaining the equivalent diameter (d) is explained.

An area (A₀) for a transverse section of the gap 30 may be obtained by subtracting an area (A2) for the transverse section of the filling member 31 from an area (A1) for that of the passage 23.

For example, if the diameter (D1) is 0.52 mm and the diameter (D2) is 0.5 mm, then the area (A₀) is:

$${A}_{0} = A 1 - A 2 = {( \frac{D 1}{2} )}^{2} π - {( \frac{D 2}{2} )}^{2} π = {( \frac{0.52}{2} )}^{2} π - {( \frac{0.5}{2} )}^{2} π = ( 0.0676 - 0.0625 ) π = 0.0051 π {mm}^{2}$$

The equivalent diameter (d) of the gap 30 is defined as the diameter of a circle that has the same area as the transverse section of the gap 30, and hence may be obtained from the following equation:

$${A}_{0} = {( \frac{d}{2} )}^{2} π$$

The value of the area (A₀) previously calculated is substituted in to obtain the equivalent diameter (d):

$$d = 2 \sqrt{\frac{{A}_{0}}{π}} = 2 \sqrt{0.005 \; 1} \approx 0.14 mm$$

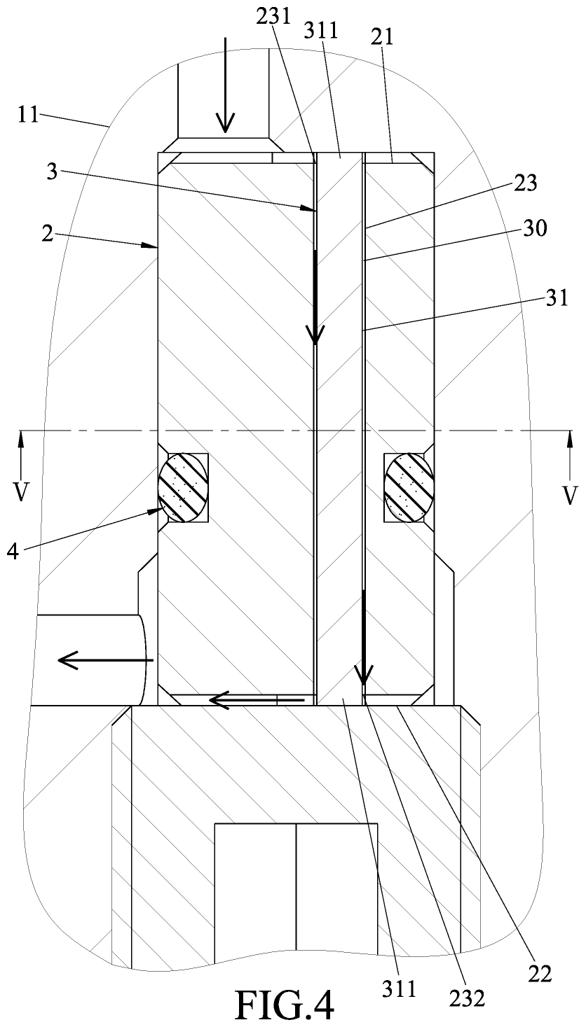

During continuous tiring, gas moves along the arrow shown in FIG. 4 into the gap 30 through the entrance section 231 of the passage 23 and into the flow path unit 12 through the exit section 232, and drives the conditioning valve assembly 13 to move such that gas flow is guided to enable firing within a predetermined delay time, or to stop firing when the predetermined delay time has been exceeded.

Further details regarding the operation of the pneumatic tool 1 may be derived by those skilled in the art from the above description and the disclosure of U.S. Pat. No. 10,335,936, and is thus omitted in this disclosure for the same of brevity. Referring to FIG. 6, in a variation of the embodiment, the transverse section of the filling member 31 has a square shape. Table 2 shows three pairs of values for the diameter (D1) of transverse section of the passage 23 and the width (D2) of the transverse section of the filling member 31, and the corresponding equivalent diameter (d) of the gap 30.

TABLE 2

| Diameter (D1) | Width (D2) | Equivalent Diameter (d) |
|---|---|---|
| 0.32 mm | 0.212 mm | 0.21 mm |
| 0.52 mm | 0.354 mm | 0.33 mm |
| 1.02 mm | 0.707 mm | 0.64 mm |

According to the abovementioned Tables 1 and 2, the equivalent diameter (d) of the gap 30 in this embodiment may range from 0.11 mm to 0.64 mm. In practice, the equivalent diameter (d) of the gap 30 generally ranges between 0.14 mm and 0.25 mm.

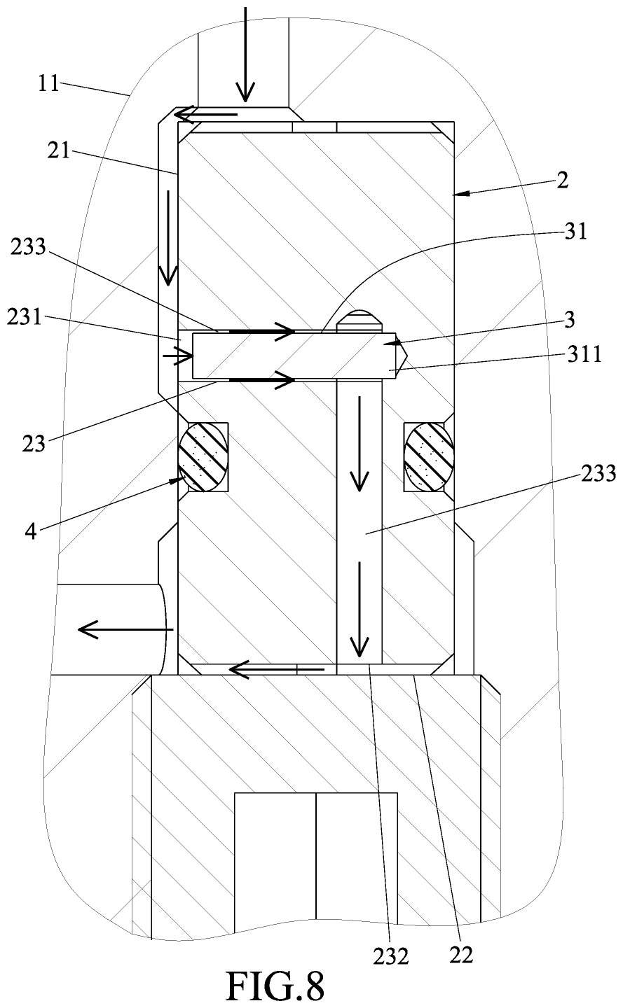

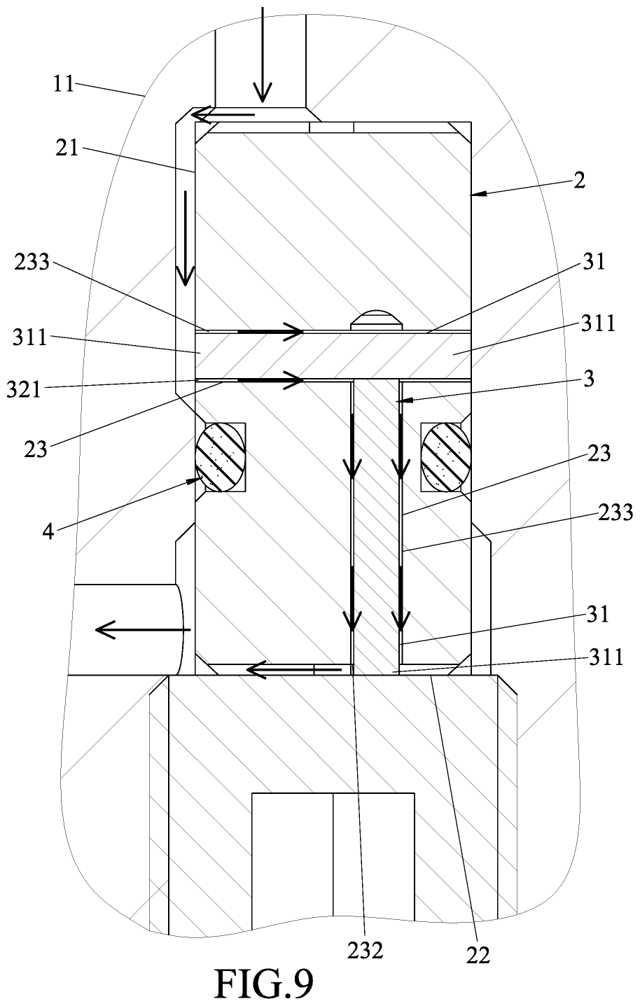

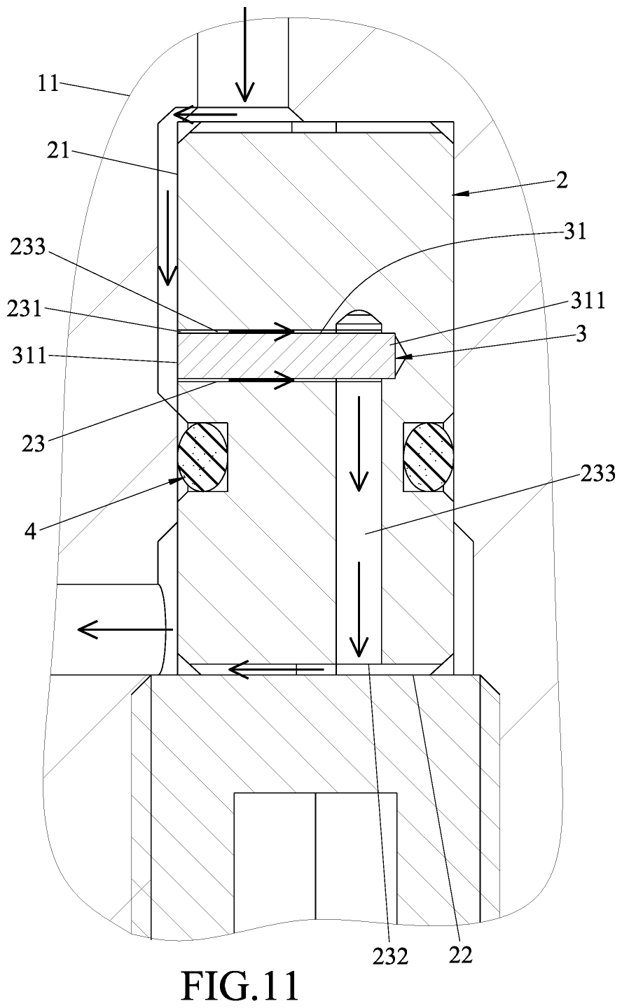

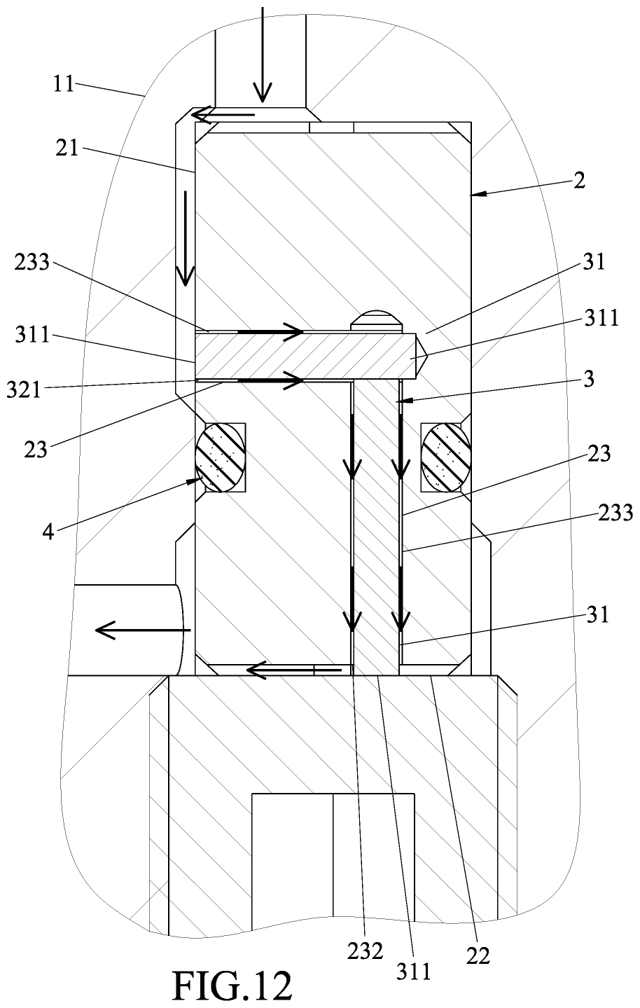

Referring to FIGS. 8, 9, 11, and 12, in another variation of the embodiment, the passage 23 may be configured to have two passage portions 233 extending transverse to each other, each of the passage portions 233 having an end that serves as a respective one of the entrance section 231 and the exit section 232 of the passage 23. The filling unit 3 may include one filling member 31 (FIGS. 8 and 11) disposed in one of the passage portions 233, or two filling members 31 (FIGS. 9 and 12) respectively disposed in the passage portions 233. The gap 30 can similarly be defined between each of the filling members 31 and the corresponding passage portion 233. In this variation, each of the mounted ends 311 of one of the mounting members 31 may be adapted to be mounted to the tool body 11, to the valve body 2, or to the other filling member 31. The passage portions 233 and the filling member(s) 31 may likewise be made to the dimensions specified in Table 1 to define the gap 30 having the equivalent diameter (d) which ranges from 0.11 mm to 0.49 mm.

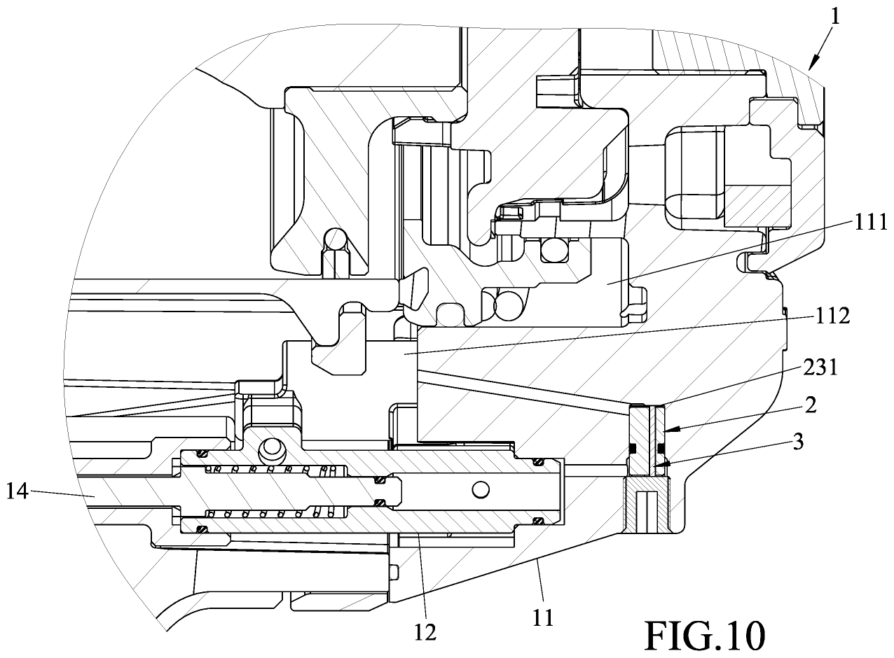

In yet another variation of the embodiment, as shown in FIG. 10, the entrance section 231 of the passage 23 is not limited to the configuration shown in FIG. 1, where it is directly communicated with the operating chamber 111, and may be directly communicated with the main chamber 112 instead.

The benefits of the throttle valve of the disclosure are as follows:

1. By creating the gap 30 between the passage 23 and the filling unit 3, the gap 30 having the relatively small equivalent diameter (d) can be produced more precisely and with a simplified process of manufacturing.

2. To adjust the delay time of the pneumatic tool 1 by adjusting the gas flow through the throttle valve, only the filling unit 3 needs to be replaced to define the gap 30 with a different equivalent diameter (d).

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A throttle valve adapted for use in a pneumatic tool, the pneumatic tool including a tool body, a flow path unit that is disposed in the tool body, and a valve assembly that is disposed inside the flow path unit, and that is movable by pressure generated from gas which flows through the flow path unit, said throttle valve comprising:
a valve body having a passage that has an entrance section formed in one end surface of said valve body, and an exit section formed in another end surface of said valve body and adapted to be connected directly to the flow path unit; and
a filling unit disposed in said passage and cooperatively defining with said valve body a gap, such that the gas flows into said gap via said entrance section of said passage, and flows out of said gap via said exit section of said passage.

2. The throttle valve as claimed in claim 1, wherein said passage further has two passage portions extending transverse to each other, each of said passage portions having an end that serves as a respective one of said entrance section and said exit section of said passage.

3. The throttle valve as claimed in claim 2, wherein said filling unit includes a filling member disposed in one of said passage portions and cooperating with said valve body to define said gap.

4. The throttle valve as claimed in claim 3, wherein said filling member has a mounted end mounted to said valve body.

5. The throttle valve as claimed in claim 3, wherein said filling member has at least one mounted end adapted to be mounted to the tool body.

6. The throttle valve as claimed in claim 3, wherein each of said said passage portions has a transverse section being circular, and said filling member has a transverse section having a shape of one of a circle, a polygon, and a truncated circle.

7. The throttle valve as claimed in claim 2, wherein said filling unit includes two filling members respectively disposed in said passage portions and cooperating with said valve body to define said gap.

8. The throttle valve as claimed in claim 7, wherein at least one of said filling members has a mounted end mounted to said valve body.

9. The throttle valve as claimed in claim 7, wherein at least one of said filling members has at least one mounted end adapted to be mounted to the tool body.

10. The throttle valve as claimed in claim 7, wherein each of said passage portions has a transverse section being circular, and each of said filling members has a transverse section having a shape of one of a circle, a polygon, and a truncated circle.

11. The throttle valve as claimed in claim 1, wherein said filling unit includes a filling member extending through said passage.

12. The throttle valve as claimed in claim 11, wherein said filling member has at least one mounted end adapted to be limited by the tool body.

13. The throttle valve as claimed in claim 11, wherein said passage has a transverse section being circular, and said filling member has a transverse section having a shape of one of a circle, a polygon, and a truncated circle.

14. The throttle valve as claimed in claim 1, wherein said filling unit has a diameter smaller than a diameter of said passage, said gap having an equivalent diameter that ranges between 0.11 mm and 0.64 mm.

15. The throttle valve as claimed in claim 14, wherein said equivalent diameter of said gap ranges between 0.14 mm and 0.25 mm.
